(19) United States
(12) Patent Application Publication
(10) Pub. No.: US 2008/0219026 A1
(43) Pub. Date: Sep. 11, 2008

(54) LIGHT GUIDE PLATE AND METHOD FOR MAKING THE SAME

(75) Inventor: WEN-WU ZHU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/746,648

(22) Filed: May 10, 2007

(30) Foreign Application Priority Data
Mar. 6, 2007 (CN) 200710200251.4

(51) Int. Cl. F21V 8/00

(52) U.S. Cl. 362/626

(57) ABSTRACT

An exemplary light guide plate includes a light output surface, a light reflective surface opposite to the light output surface, a light input surface interconnecting with the light output surface and the light reflective surface, and a plurality of microstructures formed on the light reflective surface. Each of the microstructures defines a specular reflection surface and a diffuse reflection surface. External light enters the light guide plate via the light input surface, a part of light rays undergo specular reflection at the specular reflection surfaces of the microstructures, and other parts of light rays undergo diffuse reflection at the diffuse reflection surfaces of the microstructures. A backlight module using the light guide plate can have a good optical performance.

### BACKGROUND OF THE INVENTION

1. Field of the Invention

The present invention generally relates to light guide plates and methods for making the light guide plates, and more particularly to a light guide plate for use in, for example, a backlight module of a liquid crystal display (LCD) or the like.

2. Discussion of the Related Art

In a liquid crystal display device, the liquid crystal is a substance that does not itself illuminate light. Instead, the liquid crystal relies on receiving light from a light source in order to display images and data. In a typical liquid crystal display device, a backlight module powered by electricity supplies the needed light.

Referring to FIG. 10, a typical backlight module 10 includes a light guide plate 11, a light source 13, a light reflective sheet 15, a light diffusion sheet 17 and a prism sheet 19. The light guide plate 11 includes a light output surface 112, a light reflective surface 114 opposite to the light output surface 112, a light input surface 116 interconnecting with the light output surface 112 and the light reflective surface 114, a plurality of first hemispherical microstructures 118 protruding out from the light reflective surface 114. The light source 13 is disposed adjacent to the light input surface 116. The light reflective sheet 15 is positioned under the light reflective surface 114 for reflecting light back into the light guide plate 11. The light diffusion sheet 17 is positioned above the light output surface 112 for diffusing emitted light and thereby avoiding a plurality of bright sections in the light guide plate 11. The prism sheet 19 is positioned above the light diffusion sheet 17 for collimating the emitted light uniformly to improve the light brightness.

When the backlight module 10 operates, light from the light source 13 passes through the light input surface 116 and enter the light guide plate 11. The light rays are reflected and refracted at the first hemispherical microstructures 118 of the light guide plate 11, and finally surface light rays are output from the light output surface 112. The first hemispherical microstructures 118 have mirror surfaces. Light rays from the light source 13 undergo specular reflection at the specular reflection surfaces of the first hemispherical microstructures 118. In this way, many or most of light rays emit from the light output surface 112 at angles of view from 45 degrees to 90 degrees. Accordingly, in the angles of view from 45 degrees to 90 degrees, the backlight module 10 has a good light brightness. Generally, a uniformity of light output from the backlight module 10 is low.

In order to improve uniformity of light output from the light guide plate, another typical backlight module 20 is shown as FIG. 11. The backlight module 20 includes a light guide plate 21. The light guide plate 21 is similar in principle to the light guide plate 11. However, the light guide plate 21 includes a plurality of second hemispherical microstructures 218 formed on a light reflective surface 214 thereof. Each of the second hemispherical microstructures 218 has a roughened surface that they are optical imperfect. Light rays from light source (not shown) undergo diffuse reflection at the roughened surfaces of the second hemispherical microstructures 218. In this way, a uniformity of light output from the light guide plate 21 is relatively better. Generally, in the angles of view from 45 degrees to 90 degrees, the light brightness of the backlight module 20 is low.

What is needed, therefore, is a light guide plate that overcome the conventional light guide plate not having good optical performance such as uniformity of light output and the brightness. Methods for making the light guide plate are also desired.

### SUMMARY

In one aspect, a light guide plate according to a preferred embodiment includes a light output surface, a light reflective surface opposite to the light output surface, a light input surface interconnecting with the light output surface and the light reflective surface, and a plurality of microstructures formed on the light reflective surface. Each of the microstructures defines a specular reflection surface and a diffuse reflection surface. External light enters the light guide plate via the light input surface, a part of light rays undergo specular reflection at the specular reflection surfaces of the microstructures, and other parts of light rays undergo diffuse reflection at the diffuse reflection surfaces of the microstructures.

In another aspect, a method for making a light guide plate according to another embodiment includes heating a transparent resin to a melted state; injecting the melted transparent resin into a molding chamber of an injection mold to form a light guide plate, the injection mold including a first mold and a second mold, the first mold defining a molding cavity, the first mold and the second mold cooperatively forming the molding chamber, and a plurality of microstructures formed at an inmost end of the molding cavity, each of the microstructures defining a specular reflection surface and a diffuse reflection surface; solidifying the melted transparent resin to form the light guide plate; and taking the light guide plate out of the molding chamber of the injection mold.

In a still another aspect, a method for making a light guide plate according to another embodiment includes providing a flat transparent sheet and a thermoforming machine, the thermoforming machine comprising a forming plate, and a plurality of first microstructures defined at one surface of the forming plate, each of the first microstructures defining a specular reflection surface and a diffuse reflection surface; pre-heating the flat transparent sheet; applying the forming plate to contact the flat transparent sheet with the surface having the first microstructures, and compressing the flat transparent sheet firmly until a plurality of second microstructures are formed on the surface of the flat transparent sheet; and cooling the flat transparent sheet to form the light guide plate.

Other advantages and novel features will become more apparent from the following detailed description of the preferred embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present light guide plate and methods for making the light guide plate. Moreover, in the drawings, like reference numerals designate corresponding parts throughout the several views, and all the views are schematic.

FIG. 1 is an isometric view of a light guide plate according to a first preferred embodiment of the present invention.

FIG. 2 is a side cross-sectional view of the optical plate of FIG. 1, taken along line 11-11 thereof.

FIG. 3 is an isometric view of a light guide plate according to a second preferred embodiment of the present invention.

FIG. 4 is an isometric view of a light guide plate according to a third preferred embodiment of the present invention.

FIG. 5 is a side cross-sectional view of the optical plate of FIG. 4, taken along line V-V thereof.

FIG. 6 is an isometric view of a light guide plate according to a fourth preferred embodiment of the present invention.

FIG. 7 is an isometric view of a light guide plate according to a fifth preferred embodiment of the present invention.

FIG. 8 a side, cross-sectional view of an injection mold for making the light guide plate of FIG. 1.

FIG. 9 is a side, cross-sectional view of a thermal compression mold for making the light guide plate of FIG. 4.

FIG. 10 a side, cross-sectional view of a conventional backlight module having a light guide plate.

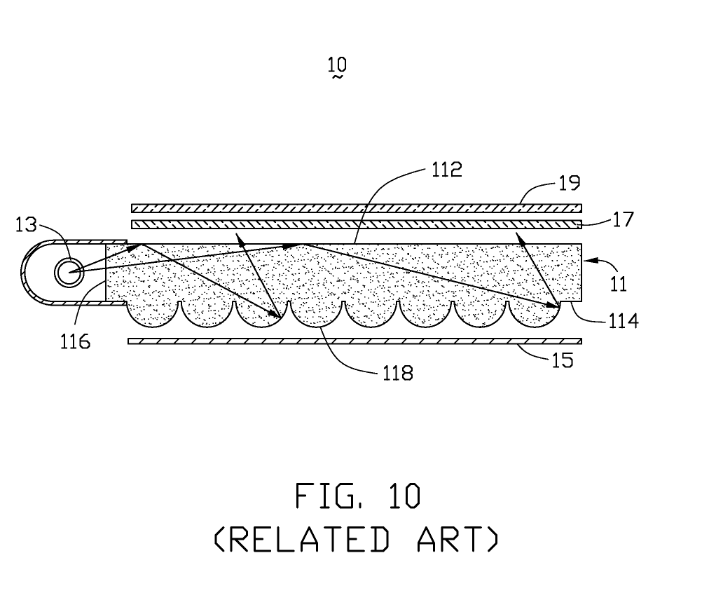

FIG. 11 is a side, cross-sectional view of another conventional light guide plate.

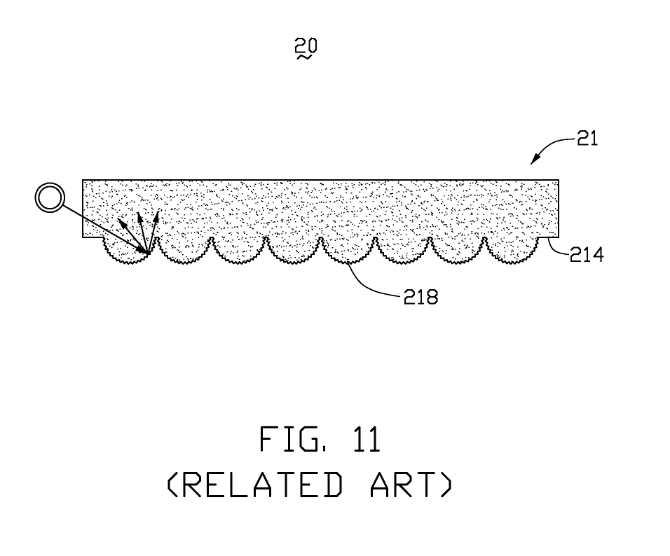

### DETAILED DESCRIPTION OF THE PREFERRED EMBODIMENTS

Reference will now be made to the drawings to describe preferred embodiments of the present light guide plate and backlight module using the same, in detail.

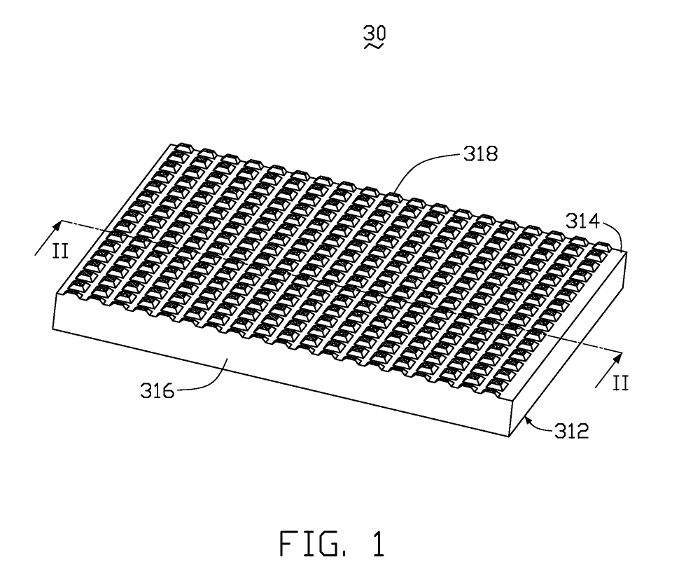

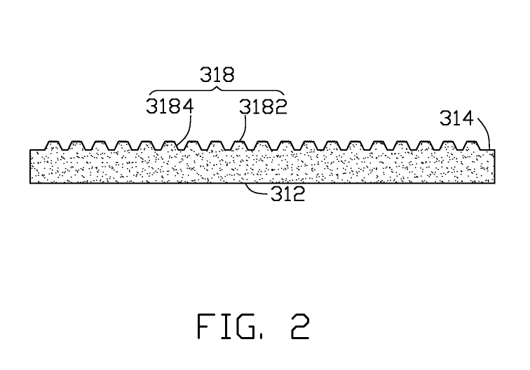

Referring to FIGS. 1 and 2, a light guide plate 30 in accordance with a first preferred embodiment of the present invention is shown. The light guide plate 30 is a rectangular sheet, and includes a light output surface 312, a light reflective surface 314, and a light input surface 316. The light reflective surface 314 is opposite to the light output surface 312. The light input surface 316 interconnects with the light output surface 312 and the light reflective surface 314. The light guide plate 30 further includes a plurality of microstructures 318 formed on the light reflective surface 314 in a matrix arrangement. In this embodiment, each microstructure 318 is a four-sided frustum protrusion that includes four side surfaces and a top surface. In alternative embodiments, the microstructures 318 can be frustums of other shapes. Each of the four-sided frustum protrusion defines a specular reflection surface 3184 on each of the four side surfaces, and defines a diffuse reflection surface 3182 on the top surface. External light from a light source (not shown) enters the light guide plate 30 via the light input surface 316, some of the light undergo specular reflection at the specular reflection surfaces 3184 in the light guide plate 30, and some of the light undergoes diffuse reflection at the diffuse reflection surface of the four-sided frustum protrusion in the light guide plate 30. Finally, the light is outputted from the light output surface 312.

In order to achieve high quality optical effects, a ratio of an area of the diffuse reflection surfaces relative to a combined area of an outer surface of the microstructures is preferably in a range from about 30% to about 70%. A roughness of the diffuse reflection surfaces is approximately equal to or larger than 0.2. In alternative embodiments, a ratio of an area of the specular reflection surfaces relative to a combined area of the outer surface of the microstructures is preferably in a range from about 30% to about 70%. A material of the light guide plate 30 is selected from polymethyl methacrylate (PMMA), polycarbonate (PC), polyacrylic acid (PAA), polyethylene resin (PE) and any other suitable transparent resin materials.

Because each microstructure 318 of the preferred light guide plate 30 has two different surfaces: the specular reflection surface and the diffuse reflection surface; the specular reflection surfaces 3184 of the microstructures 318 make most of the light emitting from the light guide plate 30 emit at angles of view from 45 degrees to 90 degrees. In addition, the microstructures 318 can diffuse light at the diffuse reflection surfaces 3182, such that the light guide plate 30 has a relatively good optical uniformity. Therefore, the backlight modules using the light guide plate 30 have a good optical performance.

It should be understood that the microstructures 318 of the light guide plate 30 are not limited to being arranged as described above. In alternative embodiments, the microstructures 318 can be arranged otherwise. For example, the microstructures 318 can be arranged randomly on the light reflective surface 314.

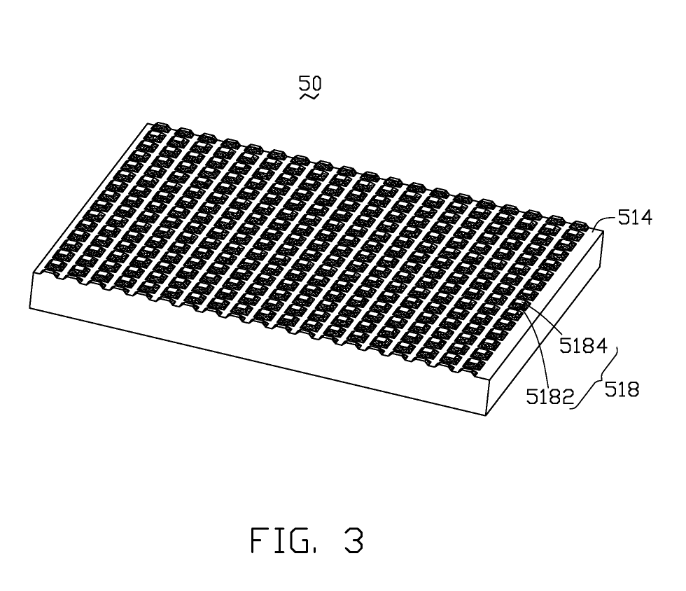

Referring to FIG. 3, a light guide plate 50, in accordance with a second preferred embodiment of the present invention, is similar in principle to the light guide plate 30 of the first embodiment. The light guide plate 50 includes a plurality of microstructures 518 formed on a light reflective surface 514. However, each microstructure 518 is a four-sided frustum protrusion that includes four side surfaces and a top surface. Each of the four-sided frustum protrusions defines a specular reflection surface 5184 at the top surface, and defines a diffuse reflection surface 5182 at the four side surfaces.

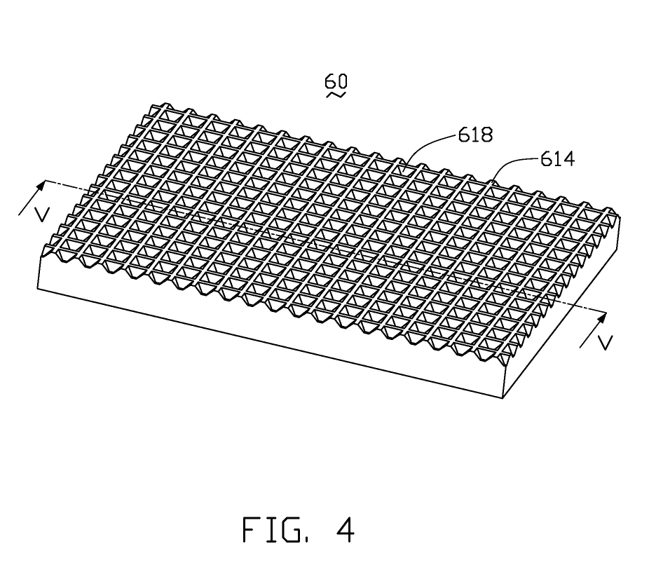

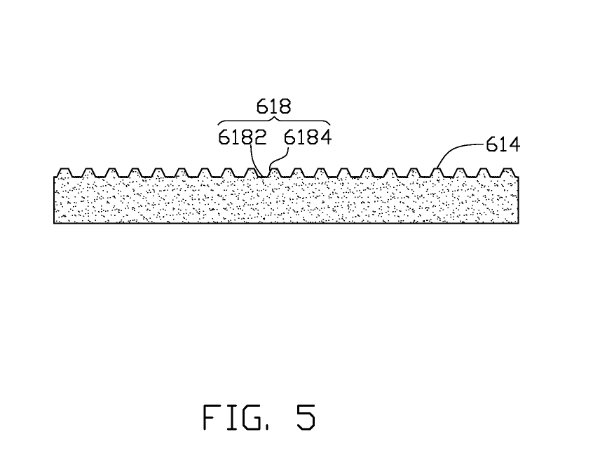

Referring to FIGS. 4 and 5, a light guide plate 60, in accordance with a third preferred embodiment of the present invention, is similar in principle to the light guide plate 30 of the first embodiment. The light guide plate 60 includes a plurality of microstructures 618 formed on a light reflective surface 614. However, each microstructure 618 is a four-sided frustum depression that includes four flat side surfaces and a bottom surface. Each of the four-sided frustum depression defines a specular reflection surface 6184 at the four flat side surfaces, and defines a diffuse reflection surface 6182 at the bottom surface.

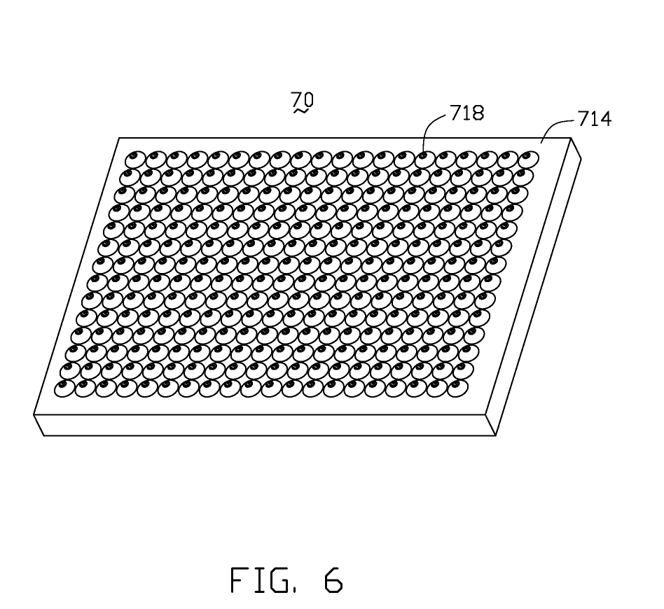

Referring to FIG. 6, a light guide plate 70, in accordance with a fourth preferred embodiment of the present invention, is similar in principle to the light guide plate 30 of the first embodiment. The light guide plate 70 includes a plurality of microstructures 718 formed on a light reflective surface 714 thereof. However, each microstructure 718 is a conical frustum protrusion that includes side surface and top surface. Each of the conical frustum protrusion defines a specular reflection surface (not labeled) at the side surface, and defines a diffuse reflection surface (not labeled) at the top surface.

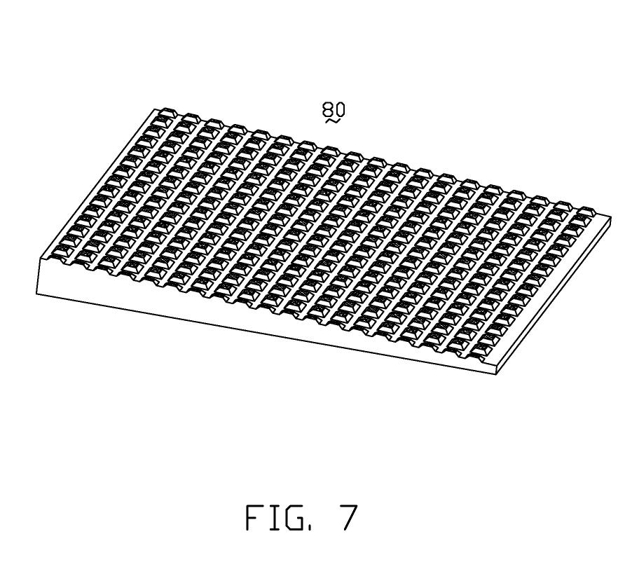

Referring to FIG. 7, a light guide plate 80, in accordance with a fifth preferred embodiment of the present invention, is similar in principle to the light guide plate 30 of the first embodiment. However, the light guide plate 80 is generally cuneiform.

It should be understood that shapes of the light guide plates 30, 50, 60, 70 and 80 are not limited to rectangular sheet or cuneiform sheet as described above. In alternative embodiments, the light guide plates 30, 50, 60, 70 and 80 can have other shapes. For example, a shape of the light guide plate is polygonal.

It should be pointed out that, the shapes microstructures 318, 518, 618 and 718 of the light guide plates 30, 50, 60 and 70 are not limited to those as described above. In alternative embodiments, the microstructures can be either protrusions or depressions. For example, the microstructures 318, 518, 618 and 718 can be one of elongated protrusions, elongated depressions, hemispherical protrusions and hemispherical depressions.

An exemplary method for making the light guide plate 30 will now be described. The light guide plate 30 is made using an injection molding technique.

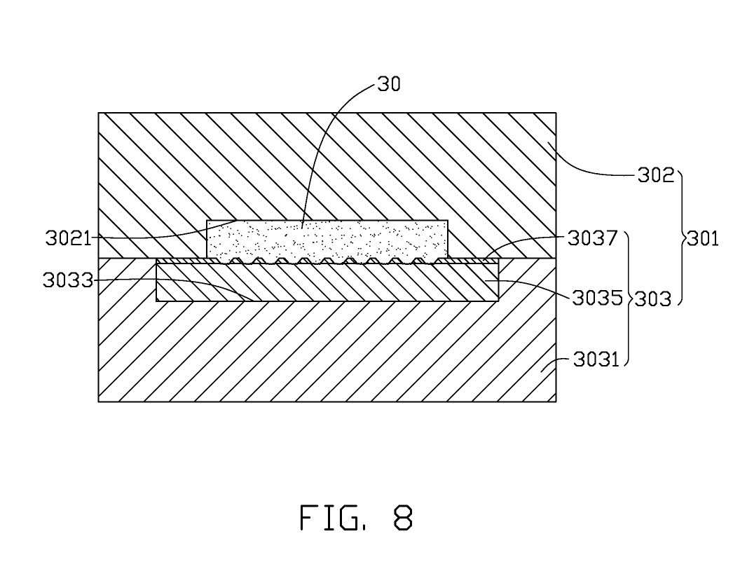

Referring to FIG. 8, an injection mold 301 is provided. The injection mold 301 includes a first mold 302 and a second mold 303. The first mold 302 defines a first molding cavity 3021. The second mold 303 includes a bottom plate 3031, a first core 3035, and a second core 3037. The bottom plate 3031 defines a second molding cavity 3033 for receiving the first core 3035 and the second core 3037 in order. The first core 3035 is positioned on a bottom of the second molding cavity 3033, and defines a plurality of rough portions (not labeled) on a top surface thereof. The second core 3037 is a thin sheet, which defines a plurality of through holes (not labeled) therein. In this embodiment, each of the through holes is a four-sided hole that includes four side inner mirror surfaces. Each of the through holes has a trapeziform cross-section that a narrower end of the through holes adjacent to the first core 3035. The second core 3037 is positioned on the first core 3035 in the second molding cavity 3033. The through holes of the second core 3037 are corresponding to the rough portions of the first core 3035. Accordingly, The first mold 302 is positioned on the second mold 303 to form a molding chamber (not labeled). The molding chamber has an inner surface that defines a plurality of four-sided frustum depressions, each of the depression defining a specular reflection surface and a diffuse reflection surface.

The method for making the light guide plate 30 mainly includes the following four steps. Firstly, a transparent resin is heated to a melted state. Secondly, the melted transparent resin is injected into the molding chamber of the injection mold 301. Thirdly, the melted transparent resin is solidified to form the light guide plate 30. Finally, the light guide plate 30 is taken out of the molding chamber of the injection mold 301.

It should be pointed out that, in this embodiment, the first core 3035 and the second core 3037 can be omitted, because a plurality of microstructures, such as the polyhedron frustum depressions, can be directly defined on the top surface of the second mold 303. It is to be understood that the microstructures can also be defined on an inmost end surface of the molding cavity 3021 of the first mold 302, and the second mold 303 is just a bottom plate.

Another exemplary method for making the light guide plate 60 will now be described. The light guide plate 60 is made using thermoforming machines.

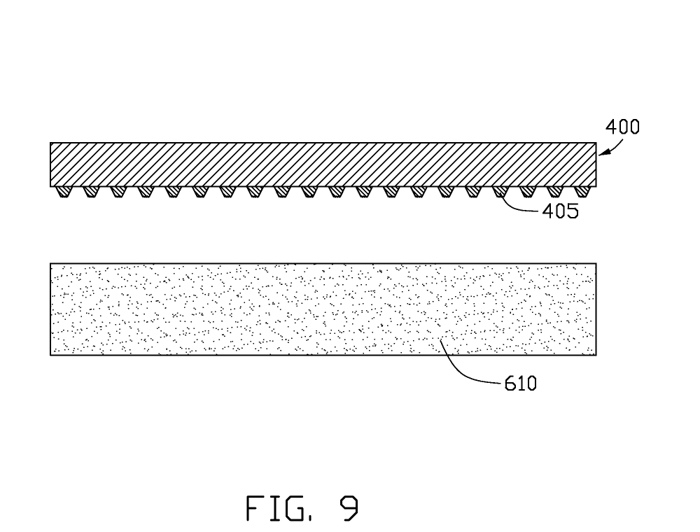

Referring to FIG. 9, a thermoforming machine (not labeled) includes a top forming plate 400. A plurality of polyhedron frustum protrusions 405 is defined at one surface of the top forming plate 400 in a matrix manner. The polyhedron frustum protrusion 405 includes four side mirror surfaces and a top rough surface.

The method for making the light guide plate 60 mainly includes the following four steps. Firstly, a flat transparent sheet 610 is positioned on a flat worktable, and the flat transparent sheet 610 is pre-heated to a soft state. Secondly, the top forming plate 400 is applied to contact the flat transparent sheet 610 with the surface having the polyhedron frustum protrusions 405, and simultaneously the flat transparent sheet 610 is compressed firmly until a plurality of polyhedron frustum depressions (not shown) are formed on the surface of the flat transparent sheet 610. Finally, the flat transparent sheet 610 is cooled to form the light guide plate 60.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A light guide plate, comprising:
a light output surface;
a light reflective surface opposite to the light output surface;
a light input surface interconnecting with the light output surface and the light reflective surface; and
a plurality of microstructures formed on the light reflective surface, each of the microstructures defining a specular reflection surface and a diffuse reflection surface, wherein external light rays enter the light guide plate via the light input surface, a part of light rays undergo specular reflection at the specular reflection surfaces of the microstructures, and other part of light rays undergo diffuse reflection at the diffuse reflection surfaces of the microstructures.

2. The light guide plate according to claim 1, wherein the microstructures are selected from one of depressions and protrusions.

3. The light guide plate according to claim 2, wherein the protrusions are selected form one of polyhedron frustum protrusion and conical frustum protrusion.

4. The light guide plate according to claim 3, wherein each of the polyhedron frustum protrusions is a four-sided frustum protrusion that defines a specular reflection surface at four side surfaces thereof, and defines a diffuse reflection surface at a top surface thereof.

5. The light guide plate according to claim 3, wherein each of the polyhedron frustum protrusions is a four-sided frustum protrusion that defines a specular reflection surface at a top surface thereof, and defines a diffuse reflection surface at four side surfaces thereof.

6. The light guide plate according to claim 3, wherein the conical frustum protrusion defines a specular reflection surface at side surface thereof, and defines a diffuse reflection surface at a top surface thereof.

7. The light guide plate according to claim 3, wherein the conical frustum protrusion defines a specular reflection surface at a top surface thereof, and defines a diffuse reflection surface at side surface thereof.

8. The light guide plate according to claim 2, wherein the depressions are selected form one of polyhedron frustum depression and conical frustum depression.

9. The light guide plate according to claim 8, wherein each of the polyhedron frustum depressions is a four-sided frustum depression that defines a specular reflection surface at four side surfaces thereof, and defines a diffuse reflection surface at a bottom surface thereof.

10. The light guide plate according to claim 8, wherein each of the polyhedron frustum depressions is a four-sided frustum depression that defines a specular reflection surface at a bottom surface thereof, and defines a diffuse reflection surface at four side surfaces thereof.

11. The light guide plate according to claim 8, wherein the conical frustum depression defines a specular reflection surface at side surface thereof, and defines a diffuse reflection surface at a bottom surface thereof.

12. The light guide plate according to claim 8, wherein the conical frustum depression defines a specular reflection surface at a bottom surface thereof, and defines a diffuse reflection surface at side surface thereof.

13. The light guide plate according to claim 1, wherein a ratio of an area of the diffuse reflection surfaces relative to a combined area of an outer surface of the microstructures is in a range from about 30% to about 70%.

14. The light guide plate according to claim 1, wherein a ratio of an area of the specular reflection surfaces relative to a combined area of the outer surface of the microstructures is preferably in a range from about 30% to about 70%.

15. The light guide plate according to claim 1, wherein a roughness of the diffuse reflection surfaces is approximately equal to or larger than about 0.2.

16. A method for making a light guide plate, comprising:
heating a transparent resin to a melted state;
injecting the melted transparent resin into a molding chamber of an injection mold to form a light guide plate, the injection mold including a first mold and a second mold, the first mold defining a molding cavity, the first mold and the second mold cooperatively forming the molding chamber, and a plurality of microstructures formed at an inmost end of the molding cavity, each of the microstructures defining a specular reflection surface and a diffuse reflection surface;
solidifying the melted transparent resin to form the light guide plate; and
taking the light guide plate out of the molding chamber of the injection mold.

17. The method for making a light guide plate as claimed in claim 16, wherein the second mold comprises a bottom plate, a first core, and a second core; the bottom plate defines a second molding cavity for receiving the first core and the second core; the first core is positioned on a bottom of the second molding cavity, and defines a plurality of rough portions on a top surface thereof; the second core is a sheet including a plurality of through holes therein, and inner surfaces of each of the through holes are mirror surfaces.

18. A method for making a light guide plate, comprising:
providing a flat transparent sheet and a thermoforming machine, the thermoforming machine comprising a forming plate, and a plurality of first microstructures defined at one surface of the forming plate, each of the first microstructures defining a specular reflection surface and a diffuse reflection surface;
pre-heating the flat transparent sheet;
applying the forming plate to contact the flat transparent sheet with the surface having the first microstructures, and compressing the flat transparent sheet firmly until a plurality of second microstructures are formed on the surface of the flat transparent sheet; and
cooling the flat transparent sheet to form the light guide plate.
